(19) United States
(12) Patent Application Publication
(10) Pub. No.: US 2009/0197741 A1
(43) Pub. Date: Aug. 6, 2009

(54) Hand, Wrist and Arm Therapy and Exercising

(75) Inventors: Gary Poillucci, Watertown, MA (US); James R. Varney, Maynard, MA (US); Bryan R. Hotaling, Harvard, MA (US)

Correspondence Address: FISH & RICHARDSON P.C., P.O BOX 1022, Minneapolis, MN, 55440-1022, US

(73) Assignee: GARY POILLUCCI

(21) Appl. No.: 12/026,879

(22) Filed: Feb. 6, 2008

(51) Int. Cl. A63B 23/14; A61H 1/00

(52) U.S. Cl. 482/44; 601/5; 601/34

(57) ABSTRACT

A hand, wrist and arm exercise and therapy device includes a finger push bar pivotally connected to a base and a wrist support with massagers for massaging the wrist during movement of the push bar. The push bar is moveable between a neutral position, an extended position and a locked stretching position. The massagers may be moved by movement of the push bar to better massage the wrist.

### TECHNICAL FIELD

This invention generally relates to personal hand, wrist and arm exercise and physical therapy devices.

### BACKGROUND

Several common medical conditions have been connected to tasks involving highly repetitive manual acts or acts necessitating wrist bending or stressful wrist and hand postures. One such condition is carpal tunnel syndrome (CTS), in which the median nerve is compressed or swollen at the wrist, leading to chronic wrist pain, numbness and muscle weakness in the forearm and hand.

It is estimated that 10% of adults suffer from CTS and common activities that have been identified as contributing to CTS include construction, typing, text messaging, sports training, cycling, crafting, push mowing and use of power tools. CTS is also thought by some medical professionals to cause heightened symptomatic responses among those suffer from osteoporosis, osteoarthritis, rheumatoid arthritis and conditions brought on by nerve and joint damage.

Similar difficulties are often experienced by those who have suffered a stroke or hand, wrist or arm trauma or who suffer from arthritis. While these conditions can make the simplest of tasks difficult or painful, a measure of relief is afforded through improved circulation, stretching of tendons, muscles and joints and strengthening of muscles.

One effective CTS preventative measure recommended by OSHA and health professionals is to take frequent breaks from repetitive activities. Software programs such as WORKRAVE™ and XWRITS™ are available to remind users to take breaks and stretch their wrists during computer keyboard usage. Health professionals have suggested wearing of wrist braces at night and during repetitive activities. Professional physical therapy techniques include soft tissue massage, conservative stretches and exercises to encourage improved circulation.

Accordingly, there is a need for a convenient personal wrist therapy device that allows users to regularly stretch, exercise and massage affected areas of the hand, wrist and arm during regular breaks from repetitive movements.

### SUMMARY

One aspect of the invention features an exercise apparatus including a base, a moveable wrist support, connected to the base and carrying a plurality of wrist massagers, and a push bar pivotally connected to the base and biased towards a neutral position and wherein the push bar and moveable wrist support are arranged and constructed such that movement of the push bar causes the massagers to move to massage the underside of a wrist supported on the massagers.

Movement of the push bar is converted into massaging movement of the massagers to provide compounded stretching and massage therapy effects.

In some implementations, the plurality of massagers is configured in a convex arrangement fore to aft and a concave arrangement side to side. Stated otherwise, “fore to aft” coincides with the longitudinal axis of a user's arm supported on the wrist support and “side to side” refers to an axis substantially perpendicular to the longitudinal axis. The convex arrangement provides for variation of pressure points while the concave arrangement cradles the wrist supported on the massagers.

In some implementations, the device further includes an adjustor for changing one of the degree of force necessary to move the bar from the neutral position, allocation of a neutral position of the push bar, and a locked position of the push bar. The adjustor serves to adjust the device to fit a user or to adjust device settings for a desired effect.

In some cases, a magnet, heater, ice pack, electric stimulus electrode or vibrator is positioned adjacent the massagers to provide additional therapeutic effects.

Another aspect of the invention features an exercise device including a base, a wrist support connected to the base, a plurality of wrist massagers arranged on the wrist support, and a push bar pivotally connected to the base at a wrist pivot, biased towards a neutral position and positioned to be engaged by extended fingers of a user to move the bar from the neutral position.

In some devices, the push bar and wrist pivot are constructed and arranged such that activation of the push bar by a user allows both linear wrist movement across the massagers and angular wrist motion.

In some devices, the push bar and massagers are arranged and configured such that angular movement of the push bar causes the massagers to move fore and aft to massage the forearm and/or wrist.

Some implementations include a tension adjustor for changing the degree of force necessary to move the bar from the neutral position, the location of a neutral position of the push bar or a locked position of the push bar. The locked position may be used to hold and stretch the wrist at a predetermined position, for example, at the end of the natural range of wrist motion.

In some implementations, the massagers include rollers supported on elastic wires and the push bar is adjustable to different radial distances from the wrist pivot to accommodate different hand sizes. The push bar may also be lengthened or shortened to accommodate both extended and gripping finger positions.

In some implementations, the wrist support is rotatably secured within a ring connected to the base to provide a range of forearm rotation orientation during movement of the push bar.

Another aspect of the invention features an exercise apparatus including a forearm brace, a push bar pivotally connected to the forearm brace and biased towards a neutral position and wherein the neutral position of the push bar may be adjusted substantial perpendicular to the forearm to stretch the wrist at or beyond the natural flexural range of wrist extension.

Attachment of the exercise device to a forearm brace allows a user to exercise without having to remain seated or positioned next to a support surface. This would even allow users to combine exercise sessions with other activities.

In some implementations, the brace is arranged and constructed to engage both the top and bottom of the forearm to provide bi-directional support and resistance.

Some configurations include a tension adjustor for changing the degree of force necessary to move the bar from the neutral position, a location of a neutral position of the push bar, or a locked position of the push bar.

Some implementations includes a magnet, heater, removable microwavable pad, ice pack, electric stimulus electrode or vibrator to increase the therapeutic effect of the massagers.

In some implementations, the push bar is movable from the neutral position in both upward and downward directions to exercise both flexor and extensor muscle groups.

In some implementations, the push bar is adjustable to different radial distances from the wrist pivot to accommodate different hand sizes or hand positions.

In some implementations, the push bar is telescoping sprung to provide a gripping exercise range of movement.

Some implementations includes a plurality of sprung finger cams extending from the push bar for exercising individual or multiple fingers. The finger cams can be rotated or locked together to be rotated in any desired combination. The finger cams can be rotated independent of rotation of the push bar. The spring tension of the finger cams can be adjusted.

Another aspect of the invention features a method of using an exercise apparatus including positioning a wrist on a wrist support connected to a base, the wrist support including a plurality of wrist massagers arranged on the wrist support to massage the under forearm of the user, engaging with fingers, a push bar pivotally connected to the base at a wrist pivot and biased towards a neutral position; and moving the bar from the neutral position by flexing and extending the hand, wrist or arm muscles to cause the massagers to massage the under forearm.

In some applications, the plurality of wrist massagers is moved in response to moving the bar from the neutral position.

In some cases, moving the bar causes the massagers to move with respect to the base.

In some applications, the bar is locked in a stretching position different than the neutral position to provided extended stretching of the wrist.

Some examples of the method include adjusting the location of the neutral position of the push bar.

Some examples of the method include heating or vibrating the massagers.

In some cases, the wrist is secured to the wrist support.

Implementations and applications of the invention provide benefits and advantages of wrist therapy and exercise in a compact, portable, personal use exercise and therapy station. It is believed that stretching, massaging, and other therapeutic effects provided by implementations and applications of the invention will afford users a measure of relief from CTS and other hand, wrist and arm related conditions.

The details of one or more examples of implementations of the invention are set forth in the accompanying drawings and the description below. Other features, objects and advantages of the invention will be apparent from the description and drawings, and from the claims.

### DESCRIPTION OF DRAWINGS

FIG. 1 is a perspective view of an exercise device.

FIG. 2 is a partial enlarged cross-sectional view taken along line 3-3 in FIG. 1 showing the massagers with spacers strung on a wrist support wire.

FIG. 3 is a perspective view of an exercise device including a wrist pivot-massager linkage for moving the massagers upon movement of the push bar.

FIG. 4 is a partial exploded view of the device of FIG. 3 showing a wrist pivot spring and wrist pivot-massager linkage.

FIG. 5 is a perspective view of another example exercise device.

FIG. 6 is a side view of an exercise device in use.

FIG. 7 is a perspective view of an exercise device having a removable microwavable wrist pad.

FIG. 8 is a perspective view of an exercise and stretching device supported by an arm brace.

FIG. 9 is a perspective view of another embodiment including finger cams on the push bar.

FIG. 10 is a perspective view of another embodiment including a rotatable pivot ring.

Like reference symbols in the various drawings indicate like elements.

### DETAILED DESCRIPTION

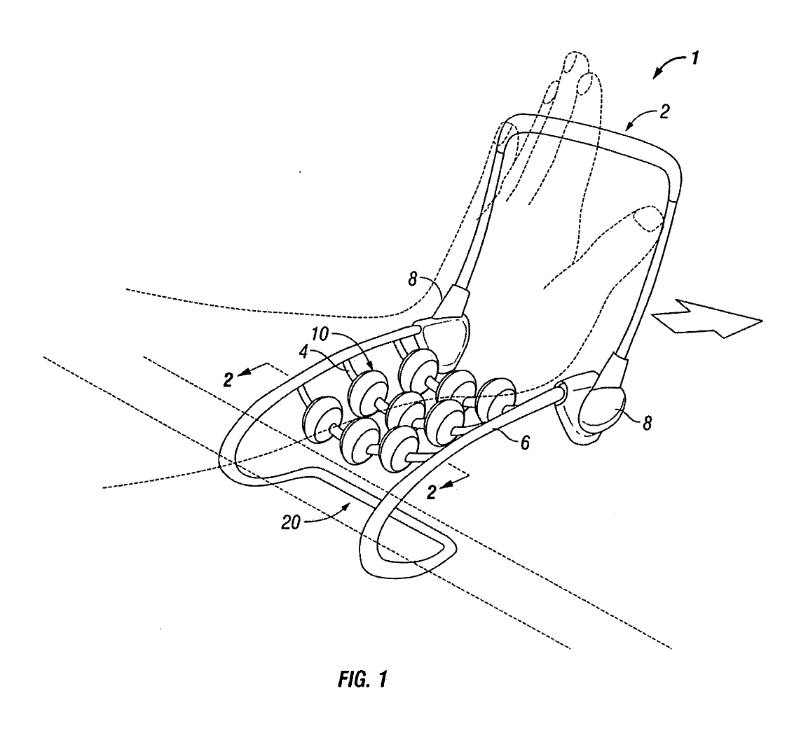

Referring to FIG. 1, an exercise and therapy device 1 features a push bar 2 positioned forward of a wrist support 4 on a base 6. Push bar 2 is pivotally connected to base 6 at wrist pivots 8 and is sprung or biased towards a resting or neutral position. Push bar 2 is positioned to be moved by the extended fingers of a user having his or her wrist resting on wrist support 4. Push bar 2 is shown here as a generally u-shaped bar connected to base 6 at wrist pivots 8. Alternatively, push bar 2 could readily be attached to base 6 with a single wrist pivot 8. The top surface of wrist support 4 includes a number of wrist massagers 10 arranged and constructed to engage the soft tissues such as muscles or tendons on the underside of the wrist/forearm as the user moves push bar 2. Massagers 10 provide spaced-apart pressure points along the wrist and forearm and allow the user to adjust the location of the pressure points as needed by repositioning or rolling the wrist during exercises.

In some cases, push bar 2 is configured or adjusted to be engaged by the fingers in the extended position, or alternatively in a gripping position. In some cases push bar 2 is padded, contoured or otherwise configured to increase user comfort. Push bar 2 is moveable in one or both directions from the neutral position. In some implementations, push bar 2 is adjusted to move the neutral position or to lock push bar 2 in a stretching position. For example, a user may lock push bar 2 at an upward extreme to stretch the wrist at or beyond the natural range of wrist motion. The locked position is adjustable, for example, through a range of stretching positions as part of an ongoing physical therapy regiment. Locking of push bar 2 may be accomplished with any friction device, shear device or other resistance mechanism suitable to fix push bar 2 relative to base 6.

Wrist support 4 is depicted in FIG. 1 as a series of wire axles carrying wrist massagers 10. Wrist support 4 is constructed in a convex arrangement fore to aft and a concave arrangement side to side to cradle the wrist. The concavity of wrist support 4 helps to align the device with the user's arm, for example to prevent kicking of base 6 to one side if the user exerts more pressure on one side of push bar 2 or if push bar 2 is sprung on a single side. The concavity of wrist support 4 allows a user to select the location of pressure to be applied to his or her forearm by wrist support 4 simply by rolling or varying the angle of his or her arm relative to wrist support 4. For example, a low angle approach will locate the massaging pressure of wrist support 4 toward the mid forearm, while a steeper angled approach will locate the pressure closer to the wrist.

The wire axles of wrist support 4 may be welded, press-fit, fastened or otherwise connected to a bent wire frame base 6. In other cases, base 6 is formed of other materials or by other processes. For example, base 6 may be injected molded using plastic or may be formed from wood or metal. Base 6 is depicted as including a lower portion for engaging the underside of a table or support surface during use. In other examples (not shown), base 6 includes a weighted base, a rubber non-slip lower surface, a suction cup, table mount bracket or other structure to help maintain base 6 in place during use. Base 6 can alternatively be mounted on a dedicated adjustable stand to provide for height adjustment for use with different therapy patients or for switching between use while standing, sitting or laying down. In some embodiments, base 6 is attached to the forearm of the user for use in any desired location or position.

Base 6 is preferably retained or secured against the edge of a table or supporting surface and stabilized against movement in multiple directions. For example, the lower portion of base 6 may be configured to provide an affirmative underedge feature to resist forward motion and may rely on friction, interference or clamping fit to the table or support surface to resist rearward or side to side motion. Such configurations may include rubberized or spring loaded jaws, a resilient lower portion of base 6 and the like.

With continued reference to FIG. 1, a method of using exercise device 1 includes positioning base 6 a comfortable distance from the user's body, positioning the user's wrist on wrist support 4, engaging push bar 2 with the user's fingers, and pushing push bar 2 from the neutral position. While push bar 2 is depicted as configured for pushing using the flexor muscles of the user, push bar 2 may be also be configured for pulling, for example using the extensor muscles of the user. Push bar 2 is moveable through a comfortable range of motion and adjustable to urge or hold the user's hand in a more extreme position, for example, for stretching or as part of physical therapy. Push bar 2 is configured to provide either a constant resistance or a graduated resistance to movement from the neutral position.

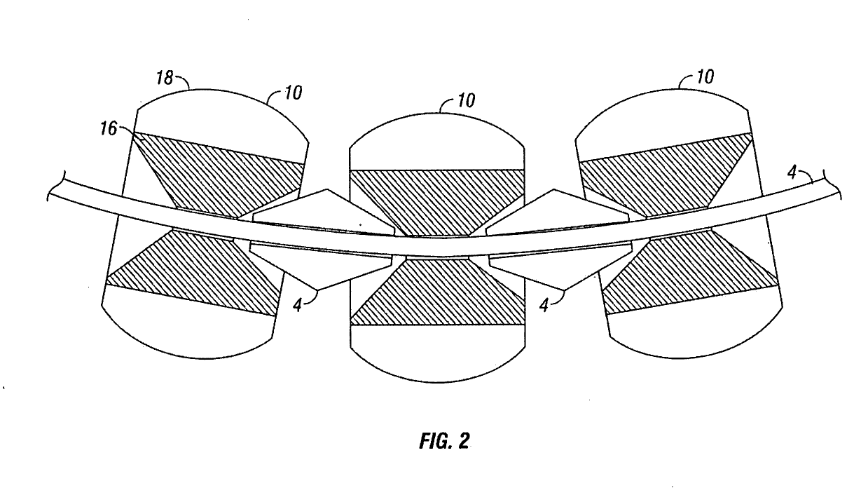

With reference to FIG. 2, wrist support 4 is configured as a wire axle carrying a number of massagers 10 separated by spacers 14 to provide individual spaced apart projections or pressure points. Massagers 10 are sized and configured to provide multiple pressure points on a user's wrist during operation of wrist exercise device 1. In other implementations, massagers 10 are arranged in abutting side-by-side series within an array. As depicted, wrist support 4 is depicted as wires carrying massagers 10. The wires may be semi-flexible or even elastic to conform to the wrist, increasing contact with massagers 10 and may be elastically deformed to be inserted into base 6. Wrist support 4 may include massagers 10 of any number, size, shape and material to provide pressure points for massaging a wrist. In some cases, massagers 10 are spheroid or ellipsoid rollers. In other cases, massagers 10 are multi-faceted, bumpy or textured to provide additional variation of pressure point application during massaging. Massagers 10 preferably provide multi-point contact to the under forearm of a user through the range of motion of push bar 2.

Massagers 10 may be formed from plastic, rubber, wood or any other material or combination of materials. Massagers 10 may be solid, hollow, layered, or may be a shell with a liquid, gel or particulate filler. Some users may find it advantageous to include magnetic materials in massagers 10. Others may prefer to have massagers be heated. Massagers 10 are depicted with a rigid inner core 16 with a pliable exterior 18. Core 16 may be of metal, wood or plastic and exterior 18 may be of foam, gel, fabric or rubber, for example, a pliable rubber overmelted on core 16. Massagers 10 may be of substantially uniform dimensions or may be oblong to provide varying degrees of pressure. Massagers 10 need not be constrained axially but may be allowed to move somewhat side to side on wrist support 4. Thus, in different implementations, massagers 10 are in direct contact with one another or are spaced apart.

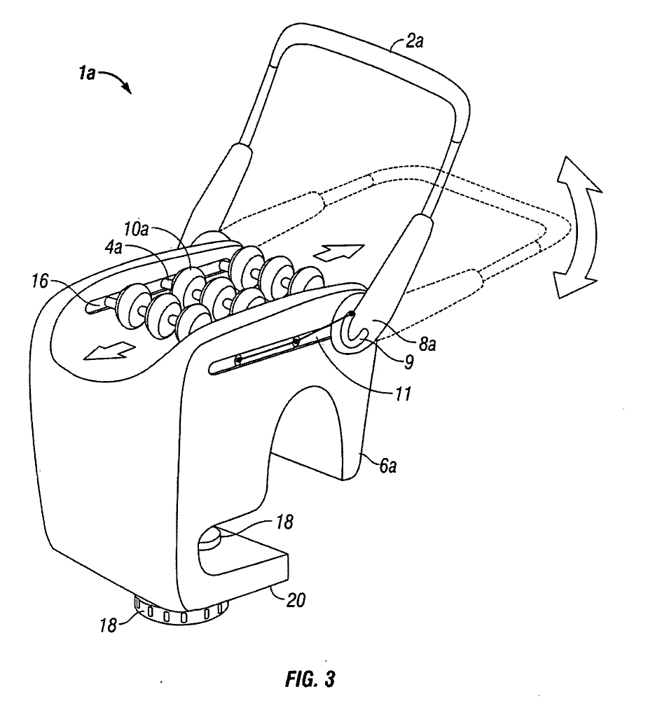

With reference to FIG. 3, exercise and therapy device 1 a features interoperability of push bar 2a and wrist support 4a such that angular movement of push bar 2a causes translation of massagers 10a. It is believed that this arrangement provides benefits of increased therapeutic massaging by movement of the pressure points of massagers 10a along the soft tissues on the underside of a user's wrist. During exercise, a user overcomes a resistance force to pivot push bar 2a in a first direction, which causes massagers 10a to translate in a first direction. Either a restoring spring force or movement by the user pivots push bar 2a in an opposite second direction, which causes massagers 10a to translate in an opposite second direction. Base 6a includes a guide 16 for guiding movement of wrist support 4. In one example, massagers 10a are guided to travel an undulated path fore to aft to provide varying degrees of pressure.

Interoperability of push bar 2a and massagers 10a may be accomplished with linkages, gears, belt drives, cable pulleys, cams and the like. For example, a cam guide 9 at wrist pivot 8 pulls a cable linkage 11 connected to wrist support 4a such that rotation of wrist pivot 8 causes wrist support 4a to move fore and aft. Cable linkage 11 is connected at one of cam guide 9 to be drawn onto or coiled around cam guide 9 upon rotation of wrist pivot 8a. Coiling of cable linkage 11 acts to shorten the linear distance between wrist pivot 8a and the connection point of cable linkage 11 to wrist support 4a, urging wrist support 4a forward. Return movement of wrist support 4 may be accomplished using a return spring or a semi-rigid linkage 11. A user may reposition his or her wrist side to side between stretching cycles to massage different portions of the wrist.

In other examples (not shown), linkage 11 is connected at opposite ends to push bar 2a and wrist support 4a distance from wrist pivot 8a such that pivoting of push bar 2 moves both ends of the linkage. Because wrist support 4a is restrained by guide 16, rotation of the push bar end of linkage 11 results in translation of the wrist support end of linkage 11.

There are numerous mechanisms (not shown) by which movement of push bar 2a may be converted into movement of wrist massagers 10a. For example, alternative configurations may include combinations of pulleys, springs, gears, cables, bar linkages and the like to accomplish similar movements.

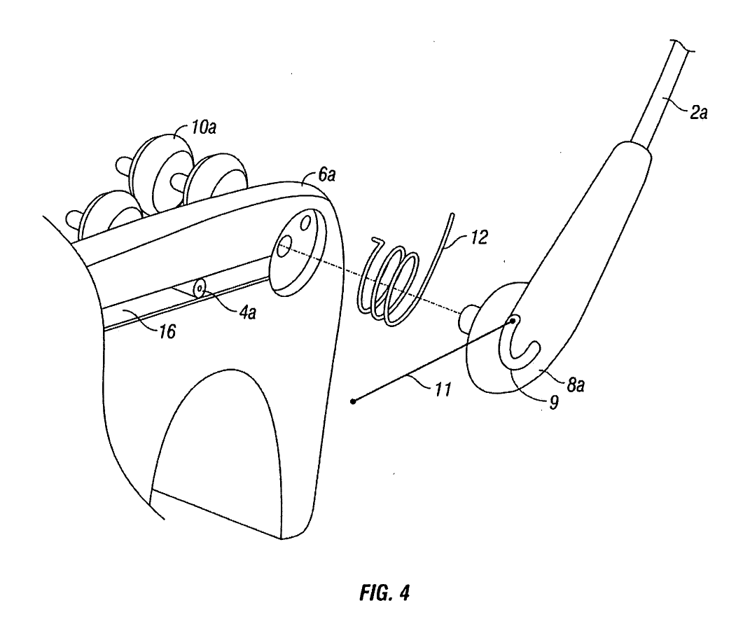

With reference to FIG. 4, wrist pivot 8a includes a spring 12 interposed between push bar 2a and base 6a to bias push bar 2a towards a neutral position. Any number of different types and locations of spring 12 may be incorporated to generate a resistive force to be overcome by a user during use of device 1a.

While wrist pivot 8a is depicted as a rotating member with spring 12 providing a resistive force, in other cases, wrist pivot 8a may be fixed with respect to base 6a and push bar 2a may be configured as a flexible member such that push bar 2a is elastically flexed about wrist pivot 8a. In such cases, linkage 11 may be attached to push bar 2a instead of wrist pivot 8a. Wrist pivot 8a is depicted as attaching to the outer side of base 6a. In other implementations (not shown), wrist pivot 8a is located on the inner side of base 6 or within a channel formed in base 6a. Push bar 2a may be removable or interchangeable by separating wrist pivot 8a from base 6a.

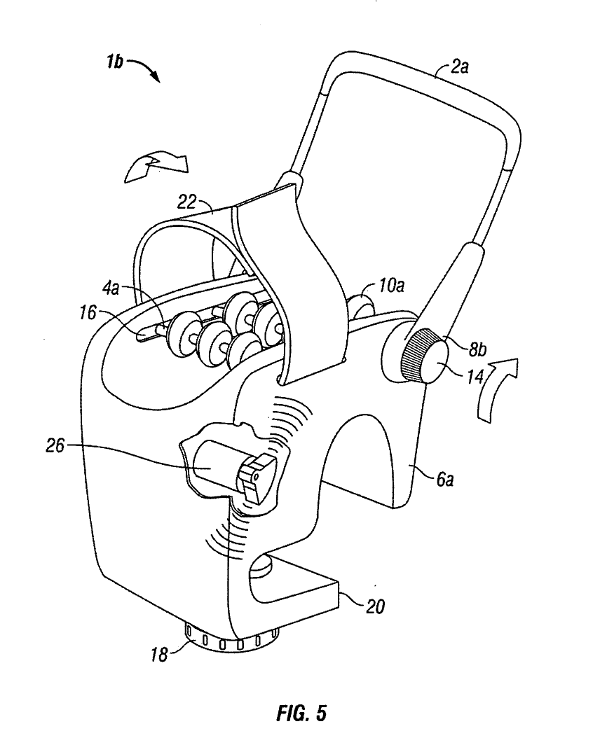

Referring to FIG. 5, wrist pivot 8b is provided with an adjustor 14 for adjusting various push bar settings, such as the degree of resistive force or bias provided by spring 12 (shown in FIG. 4). Adjustor 14 is a dial configured to wind or unwind spring 12. Adjustor 14 may alternatively or additionally serve to adjust the location of the neutral position, i.e. the resting position of spring bar 2a relative to base 6a, or the location of a locked stretching position. Adjustor 14 serves in other cases to adjust the position of various stop members (not shown) associated with wrist pivot 8b to define a desired range of motion of push bar 2a. For example, stop members may be used to limit the range of push bar movement to a prescribed range of wrist movement for physical therapy. Alternatively, push bar settings may be adjusted to provide greater resistance in one direction than another or to select between constant and graduated resistance.

Still in other cases, adjustor 14 serves to lock push bar 2a relative to base 6a, for example, to provide a fixed stretching position for a user or to lock push bar 2a in a stowed or collapsed position adjacent base 6a. Thus the neutral position of push bar 2a is adjustable within a range of motion of the user's wrist or for stretching at or beyond the end of a comfortable range of movement. For example, push bar 2a may be sprung towards an extreme upwards position but may be temporarily locked in a lower position to allow a user to position his or her wrist and hand before releasing push bar 2a to stretch the hand upwards.

Additional adjustment may be provided to fit device components to a given user or to otherwise render wrist exercise and therapy device 1 more ergonomic or effective. For example, push bar 2a is adjustable in some cases, by sliding or telescoping to adjust the radial distance from base 6a. This allows a single device to be used for a range of hand sizes or for a range of hand positions, such as with push bar 2a engaged by extended fingers or with push bar 2a gripped to varying degrees by the user's fingers. Push bar 2a can be telescopingly sprung such that push bar 2a can be compressed in a gripping motion. Combined radial and telescoping mobility provide a wider range of possible exercise and stretching positions.

Other device adjustments such as varying the height of base 6a, angle of wrist support 4a and the like may be provided in various examples. Adjustability of push bar length or angle, base height or angle, and wrist support arrangement may be provided by varying any number of sliding, graduated, or incremental positional relationships between any of the components described herein.

Base 6a is provided with a wrist strap 22 over wrist support 4a. Wrist strap 22 allows a user to further immobilize his or her arm to better isolate muscles for strengthening or stretching. For example, wrist strap 22 allows a user to move push bar 2a in both upward and downward extensions without inadvertently lifting his or her arm from wrist support 4a.

Base 6a further includes a clamp 18 for securing device 1b to a support structure such as an office desk or table. Clamp 18 is depicted as a thumb screw extending through a lower clamping flange 20. In other cases, clamping is accomplished by spring loaded jaws, interference fits with high friction members and the like. Still in other cases, such as that shown in FIG. 1, clamping flange 20 serves as an underedge table brace to simply prevent forward and upward movement of base 6a during forward and downward movement of push bar 2a. Alternatively, attachment or stability may be provided by suction cups, adhesive mounting tabs, rubber non-slip projections or other passive attachment or active clamping arrangements.

A secondary therapeutic device 26 is provided in base 6a or on wrist support 4a to provide additional therapeutic effects. Secondary therapeutic device 26 can be an eccentric weight vibrator, heater, heat pack, ice pack or electric stimulus electrode and can be powered by batteries, chemical reaction or a plug-in adapter. For example, heat packs, ice packs or electrodes may be provided on wrist support 4a or may be worn by the user during stretching. Thus, a user may benefit from the combined therapeutic effects of stretching, massaging, vibrating, icing, heating and stimulating his or her hand, wrist and arm during physical therapy or during breaks from repetitive or stressful activities. Some users may also find it beneficial to include magnetic materials or other therapeutic materials in massagers 10a.

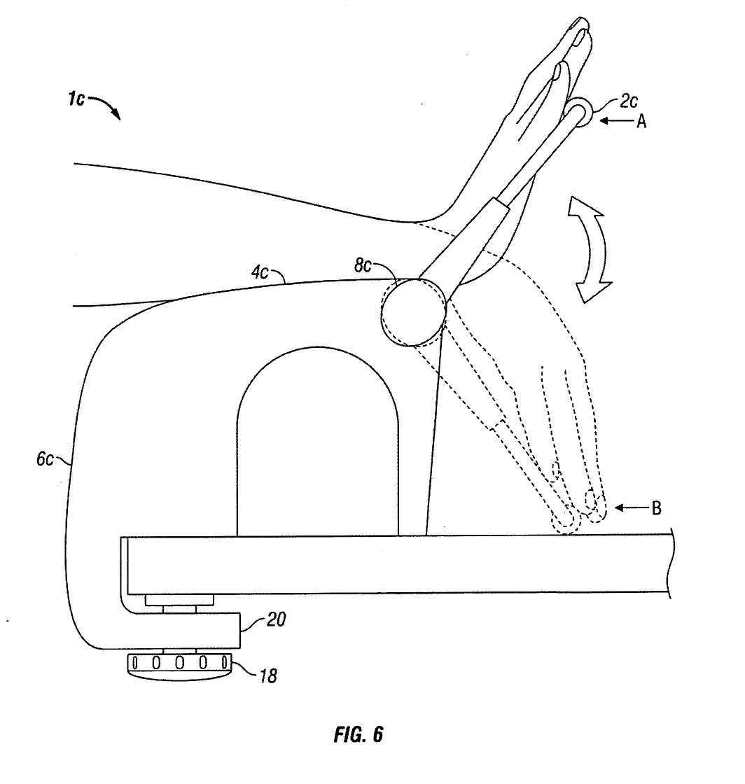

FIG. 6 illustrates a side view of an exercise device 1c in operation. In preparation for use, flange 20 is positioned below a supporting surface and clamp 18 is tightened to firmly secure base 6c in position on the supporting surface. The user rests his or her wrist on wrist support 4c and engages push bar 2c with his or her fingers. The user moves push bar 2c from a first neutral position A to a second extended position B. Wrist pivot 8c and wrist support 4c are preferably sufficiently elevated above the support surface to allow a full extension within a comfortable tolerance range of the user. For example, wrist pivot 8c is shown at a height proportionate to the distance between the wrist and fingertips. As discussed above, base 6c may be adjustable on the support surface or wrist support 4 on base 6c to achieve a desired device or wrist support angle.

Neutral position A may be adjusted somewhere between the depicted positions A and B. For example, neutral position A may be adjusted such that push bar 2c extends substantially horizontal to a support surface so that a user may overcome the restorative force of spring 12 with either an upward or downward deflection of the wrist. The user may position his or her fingers on either side of push bar 2c to select upward or downward extensions. Alternatively, push bar 2c may be fitted with a finger loop, strap or cup to permit alternating bidirectional extensions without repositioning of the fingers on push bar 2c.

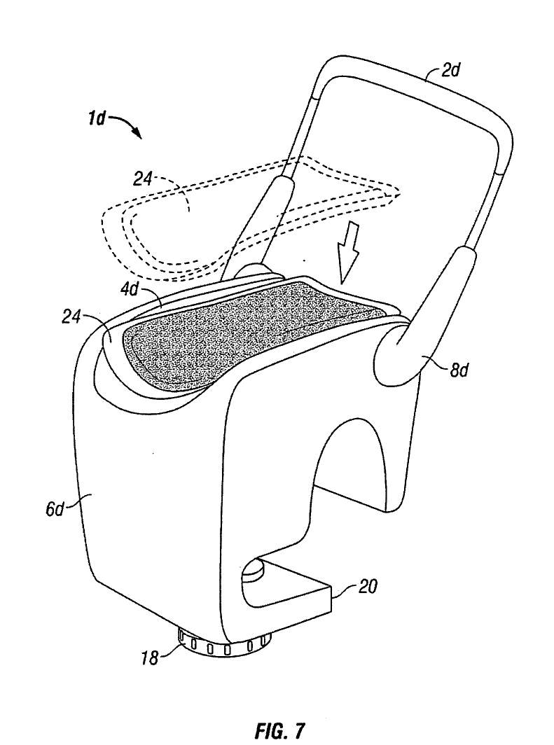

Referring to FIG. 7, an exercise device 1d includes a wrist pad 24 over wrist support 4d. Wrist pad 24 can be a removable microwavable heating pad or ice pack used to increase the therapeutic effect of massagers (not shown) during use of device 1d. In some cases, wrist pad 24 is moveable with wrist support 4d and is configured with raised bumps. In other cases, wrist pad 24 overlays individual spaced apart massagers. Wrist pad 24 includes a flexible solid, gel, or contained liquid or granular layer selected to retain heat over the course of a physical therapy session. Wrist pad 24 may be configured to be thin so as not to stifle the effects of massagers under wrist pad 24. Alternatively, extended heat therapy may be obtained with a thicker wrist pad 24. In other cases, a simple fabric sling or cover is provided over the massagers.

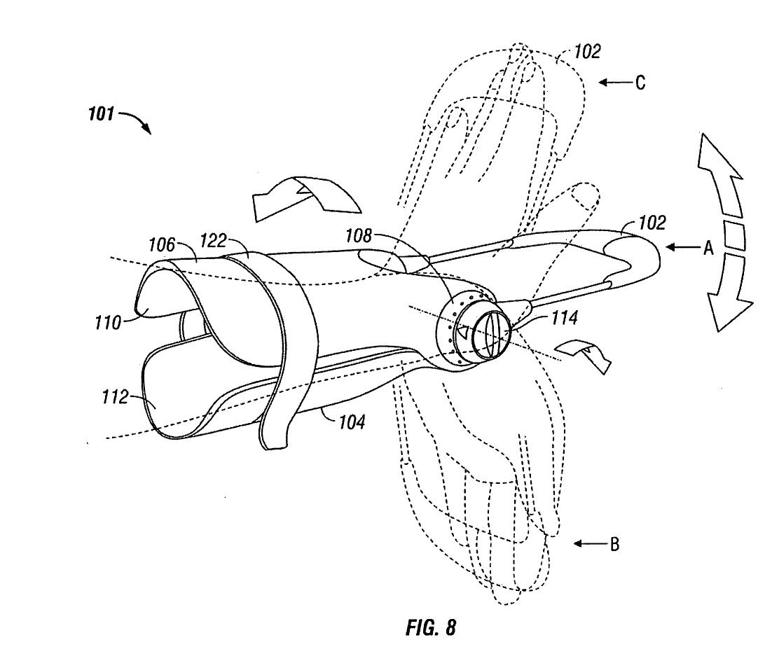

Referring to FIG. 8, an exercise device 101 includes a base 106 arranged and constructed as a forearm brace having upper and lower brace portions 110 and 112. Thus, the forearm serves as the support or base for device 101 and serves to resist the counter-movement of device 101 in response to a movement of push bar 102. Wrist support 104 is formed by a forward section of the lower brace portion 112. Removal of strap 122 allows the user to separate portions 110 and 112 to place base 6 on the forearm. Strap 122 is then tightened and secured to hold portions 110 and 112 in a closed position on the forearm. Accordingly, device 101 need not be clamped to or rested on a stationary surface, but may be constructed as a fully portable personal exercise and therapy device for use in any orientation.

Push bar 102 is depicted in a first neutral position A, a second extend position B and a third locked stretching position C. Locked position C is adjustable by a user for a desired degree or range of stretching. Wrist pivot 108 includes an adjustor 114 for setting the resistance of push bar 102 and/or the range or location of positions A, B and C of push bar 102. Push bar 102 maybe padded, contoured or otherwise configured to increase user comfort.

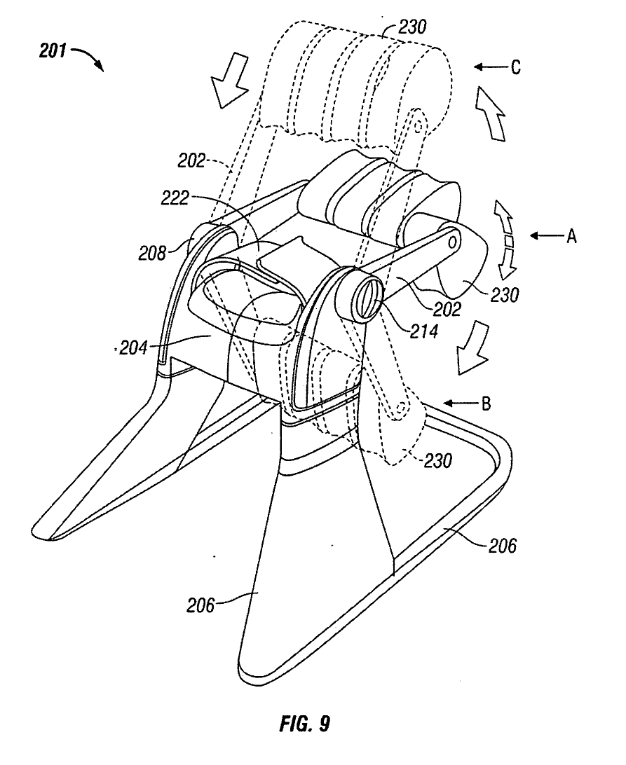

Referring to FIG 9, an exercise device 201 includes individual sprung finger cams 230 rotatably connected to push bar 202 and engaged by fingers to provide strengthening and stretching of the finger muscles. A user may position his or her wrist with the palm facing up or down for comfort as desired during operation of device 201. Finger cams 230 may be constructed of different lengths to accommodate different finger lengths and push bar 202 with finger cams 230 may be adjustable to accommodate different hand sizes. As similarly described with regard to adjustor 214, adjustment may be provided for finger cams 230 for spring forces, range of motion, neutral positioning and the like. Push bar 202 is moveable about wrist pivot 208 between a neutral position A, a flexed position B and an extended position C.

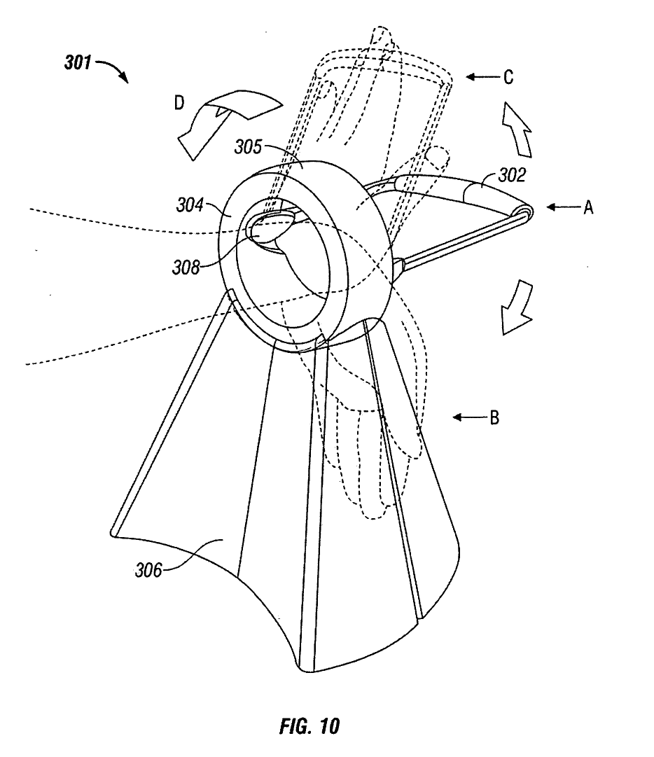

Still another embodiment, illustrated in FIG. 10, features an exercise device 301 having a base 306 and a wrist support 304 rotatably secured within a ring 305 connected to base 306. In this embodiment, a user is not limited to palm up or palm down hand orientation, but may rotate wrist support 304 as indicated by arrow D to operate device 301 with the palm and wrist in any desired orientation. Accordingly, a user may rotate his or her forearm before or while extending his or her wrist between positions A, B and C. Base 306 is preferable weighted or clamped to resist side-to-side movement of push bar 302.

A number of implementations of features of the invention have been described. Nevertheless, it will be understood that various modifications may be made without departing from the spirit and scope of the invention. For example, movement of the various components may be automated to mechanically stretch the fingers, hand, wrist or arm of the user. In an alternative implementation, a wrist support is rotatably secured within a slip ring connected to the base to allow a range of arm rotation of at least 180 degrees while the user extends his or her wrist between positions A, B and C. Accordingly, other devices and methods are within the scope of the following claims.

What is claimed is:

1. An exercise apparatus comprising:
a base;
a moveable wrist support connected to the base and carrying a plurality of wrist massagers; and
a push bar pivotally connected to the base and biased towards a neutral position and wherein the push bar and moveable wrist support are arranged and constructed such that movement of the push bar causes the massagers to move to massage the underside of a wrist supported on the massagers.

2. The apparatus of claim 1, wherein the plurality of massagers is configured in a convex arrangement parallel to the longitudinal axis of an arm supported on the wrist support and a concave arrangement perpendicular to the longitudinal axis.

3. The apparatus of claim 1, wherein the wrist massagers are individually pivotable rollers.

4. The apparatus of claim 1, further comprising a tension adjustor for changing one of the degree of force necessary to move the bar from the neutral position, a location of a neutral position of the push bar, and a locked stretching position of the push bar.

5. The apparatus of claim 1, further comprising a plurality of sprung finger cams extending from the push bar for exercising fingers.

6. The apparatus of claim 1, wherein the wrist massagers are spaced apart to define respective spaced-apart pressure points against the underside of the supported wrist.

7. The apparatus of claim 1, further comprising a heater, heat pack, ice pack, electric stimulus electrode or vibrator adjacent the massagers.

8. An exercise apparatus comprising:
a base;
a wrist support connected to the base;
a plurality of wrist massagers arranged on the wrist support; and
a push bar pivotally connected to the base at a wrist pivot, biased towards a neutral position and positioned to be engaged by extended fingers of a user to move the bar from the neutral position.

9. The apparatus of claim 8, wherein the push bar and wrist pivot are constructed and arranged such that activation of the push bar by a user allows both linear wrist movement across the massagers and angular wrist movement.

10. The apparatus of claim 8, wherein the push bar and massagers are arranged and configured such that angular movement of the push bar causes the massagers to move.

11. The apparatus of claim 8, further comprising a tension adjustor for changing one of the degree of force necessary to move the bar from the neutral position, a location of a neutral position of the push bar, and a locked position of the push bar.

12. The apparatus of claim 8, wherein the massagers comprise individual spaced apart rollers supported on wires.

13. The apparatus of claim 8, wherein the push bar is adjustable to different radial distances from the wrist pivot to accommodate different hand sizes.

14. The apparatus of claim 8, further comprising a ring connected to the base and wherein the wrist support is rotatably secured within the ring to provide a range of rotational forearm orientation.

15. An exercise apparatus comprising:
a forearm brace;
a push bar pivotally connected to the forearm brace and biased towards a neutral position and wherein the neutral position of the push bar may be adjusted substantially perpendicular to the orientation of the forearm to stretch the wrist beyond the natural wrist extension range.

16. The apparatus of claim 15, wherein the brace is arranged and constructed to engage both the top and bottom of the forearm.

17. The apparatus of claim 15, further comprising a tension adjustor for changing one of the degree of force necessary to move the bar from the neutral position, a location of a neutral position of the push bar, and a locked position of the push bar.

18. The apparatus of claim 15, further comprising a removable microwavable pad.

19. The apparatus of claim 15, wherein the push bar is adjustable to different radial distances from the wrist pivot to accommodate different hand sizes.

20. The apparatus of claim 15, wherein the push bar is telescopingly sprung to provide a range of gripping movement.

21. The apparatus of claim 15, further comprising a plurality of sprung finger cams extending from the push bar for exercising fingers.

22. A method of using an exercise apparatus comprising:
supporting a wrist on a wrist support connected to a base, the wrist support including a plurality of wrist massagers arranged on the wrist support to massage the under forearm of the user;
engaging a push bar pivotally connected to the base at a wrist pivot and biased towards a neutral position; and
moving the bar from the neutral position by flexing and extending the wrist muscles to cause the massagers to massage the under forearm.

23. The method of claim 22, further comprising moving the plurality of wrist massagers in response to moving the bar from the neutral position.

24. The method of claim 22, wherein moving the bar causes the massagers to move with respect to the base.

25. The method of claim 22, further comprising locking the bar in a stretching position different than the neutral position to provided extended stretching of the wrist.

26. The method of claim 22, further comprising adjusting the location of the neutral position of the push bar.
